(19) United States
(12) Patent Application Publication
(10) Pub. No.: US 2024/0100489 A1
(43) Pub. Date: Mar. 28, 2024

(54) Carbon-based Systems for Simultaneous Adsorption and Release of Small Molecules

(71) Applicant: CaroMeats Inc., Kitchener (CA)

(72) Inventor: Alireza Shahin-Shamsabadi, Kitchener (CA)

(73) Assignee: CaroMeats Inc., Kitchener (CA)

(21) Appl. No.: 17/952,355

(22) Filed: Sep. 26, 2022

(51) Int. Cl. B01D 71/10; B01D 67/00; B01D 71/02

(52) U.S. Cl. CPC B01D 71/10; B01D 67/0083; B01D 67/00933; B01D 67/0095; B01D 71/021; B01D 2323/30

(57) ABSTRACT

Compositions and processes for fabricating filter units containing carbon-based materials, including but not limited to activated carbon and charcoal powders are disclosed. The powders are embedded within a polymeric porous network, including but not limited to methylcellulose, that is crosslinked with citric acid to create the functioning units. These units can be used to filter out specific molecules from any solution. They can also be allowed to absorb certain molecules and then release these molecules when they are contacted with another solution. The absorption and release of different molecules can be performed simultaneously. By controlling the properties of the polymeric network, such as the chemical properties of the network, the pore sizes and porosity, and the degree of crosslinking, the absorption and release rates of different molecules can be adjusted. In order to selectively control the transport of small molecules with certain sizes, the units can be enclosed in dialysis membranes with different molecular weight cut-offs to limit the size of molecules that can be absorbed and/or filtered by the unit based on their molecular weight.

### FIELD OF THE INVENTION

The present invention relates to compositions and methods for accomplishing better cell viability and health, higher amounts of cell growth and/or differentiation in in vitro cultures of mammalian cells. The present invention also relates to compositions, methods, and processes of making cell cultures more amenable to enhanced cell function by use of carbon-based filters.

### BACKGROUND OF THE INVENTION

Mammalian cell culture is one of the most common methods for the commercial production of recombinant proteins and for the isolation of endogenous proteins from those cells. However, higher cell densities in these cultures are still limited due to factors such as excessive ammonium production, lactic acid production, nutrient limitation, and/or hyperosmotic stress related to nutrient feeds and base additions to control pH.

The culture of mammalian cells in vitro changes their metabolism compared to in vivo conditions and results in higher glycolysis and glutaminolysis rates, which correspondingly results in higher lactate and ammonia production. The increased lactate and ammonia concentrations, in both stationary and stirred cultures, which sometimes also occurs in other cells culture, such as bacteria, reduces the cells' growth and protein production. Increases in lactate and ammonia also increase cell-specific glucose and glutamine consumption rates, while also reducing the oxygen consumption rate of the cells. On the other hand, increasing the concentration of only one or the other of lactate or ammonia increases the production rate of the other one by the cells. The increase in concentration of lactic acid and ammonia results in decreasing the intracellular pH and acidification, which reduces, and even inhibits, cells' growth, metabolism, and their specific productivity. The increase in lactic acid and ammonia can eventually result in apoptosis.

Lactic acid is widely used in different industries, including medicine, brewing, and in the manufacture of different foodstuffs. Lactic acid can also be used as an ingredient in the production of biodegradable plastics that are renewable. Ammonia is also used in many different applications, such as its use for green fuels in transportation, fertilizers in agriculture, and other synthetic and therapeutic applications, among other applications. Considering their undesired effects in cell culture, their elevated production rates in in vitro culture systems, and their needed applications in other industries, lactic acid (and lactate) and ammonia, and their subsequent extraction and separation from culture medium, are an interesting and highly needed topic of research.

One of the most commonly used methods to inhibit excessive accumulation of lactate and ammonia in cell culture systems is to replace the spent medium (i.e., the medium that has high levels of lactate acid and ammonia) with fresh medium frequently. However, this replenishment tends to be very costly because the inhibitory concentrations of these factors are achieved in culture quickly, while the concentrations of other elements in the medium are still high and are replaced without being used by the cells. Alternative methods for selectively removing undesired elements from the medium and culture broth have been suggested. Three of these major techniques for removing these undesired factors include membrane techniques, extractive processes, and ion exchange resins. Membranes have very high capital cost and short lifetimes, extractive processes use solvents that are toxic to the microorganisms, and ion exchange resins are very costly.

Alternatively, activated carbon (AC), as a highly porous material that has a high surface area ratio, has high affinity for organic materials and physically adsorbs polar materials such as alcohols and acids. The adsorbed materials can be desorbed by treating AC with solvents such as acetone or sodium hydroxide solution to be used in other applications. Putting culture broth or medium directly in contact with AC can result in uncontrolled adsorption of different components of the solution to the particles, with uncontrolled rates. As a result, the treated culture medium might not be suitable for reusing with the cells. It is with these drawbacks in mind that the present invention was developed.

### BRIEF SUMMARY OF THE INVENTION

The present invention describes a process for fabricating filter units containing carbon-based materials, including but not limited to activated carbon and charcoal powders. The powders are embedded within a polymeric porous network, including but not limited to methylcellulose, that is crosslinked with citric acid to create the functioning units. These units can be used to filter out specific molecules from any solution. They can also be allowed to absorb certain molecules and then release these molecules when they are contacted with another solution. The absorption and release of different molecules can be performed simultaneously. By controlling the properties of the polymeric network, such as the chemical properties of the network, the pore sizes and porosity, and the degree of crosslinking, the absorption and release rates of different molecules can be adjusted. In order to selectively control the transport of small molecules with certain sizes, the units can be enclosed in dialysis membranes with different molecular weight cut-offs to limit the size of molecules that can be absorbed and/or filtered by the unit based on their molecular weight. Embedding carbon-based powders in the polymeric network will stabilize powders and prevent them from contaminating the liquid. It is also possible to extract the absorbed molecules from the unit and reuse the units by treating them with proper solvents or other liquid solutions, such as sodium hydroxide with the proper molarity. The units can then be reused without adversely affecting their performance.

These units can be fabricated from natural materials and can be used to increase the sustainability of the process and lower the cost of cell culture in bioreactors and fermenters for different cell types, including mammalian cells, but their use is not limited to such applications and can be used in any situation where organic components need to be separated from a solution. These units can also be used to continuously remove undesired elements from the solution by directly putting the final product (unit enclosed in dialysis membrane) in contact with the solution or perfusing the solution through the units using hollow fibers with defined cut-offs to keep the concentration of lactate and ammonia at low amounts, significantly lower than their toxic thresholds, to improve performance of cells.

### BRIEF DESCRIPTION OF THE SEVERAL VIEWS OF THE DRAWINGS

FIG. 1 shows an embodiment of the process of the present invention for making polymeric units with carbon-based particles embedded in a network.

FIGS. 2A, 2B, and 2C show a plurality of embodiments of how the carbon particles can adsorb the target molecules.

FIGS. 3A and 3B show hollow fiber tubes that have been inserted into the filter units of the present invention to limit the molecules that can be absorbed by the units based on their molecular weight.

FIGS. 4A, 4B, and 4C show the absorption and desorption of molecules in the absence and presence of a molecular weight cut-off dialysis membrane.

FIGS. 5A, 5B, 5C, and 5D show various carriers that can be used in conjunction with the filter units of the present invention.

FIG. 6 shows a process by which desorption and isolation of a molecule of interest may occur.

FIGS. 7A, 7B and 7C show a process by which different molecules can be selectively absorbed and/or desorbed to and/or from the filter unit by the selective use of different molecular weight cut-off dialysis membranes.

FIGS. 8A, 8B, 8C, and 8D show the results of experiments with a methyl cellulosic polymeric matrix comprising activated carbon demonstrating that the filter units of the present invention can be used to both absorb/adsorb and desorb targeted molecules.

### DETAILED DESCRIPTION OF THE INVENTION

The present invention describes a process for fabricating filter units containing carbon-based materials, including but not limited to activated carbon and charcoal powders. The powders are embedded within a polymeric porous network, including but not limited to methylcellulose, that is crosslinked with citric acid to create the functioning units. These units can be used to filter out specific molecules from any solution. They can also be allowed to absorb certain molecules and then release these molecules when they are contacted with another solution. The absorption and release of different molecules can be performed simultaneously. By controlling the properties of the polymeric network, such as the chemical properties of the network, the pore sizes and porosity, the degree of crosslinking, and the amount of carbon particles the absorption and release rates of different molecules can be adjusted. In order to selectively control the transport of small molecules with certain sizes, the units can be enclosed in dialysis membranes with different molecular weight cut-offs to limit the size of molecules that can be absorbed and/or filtered by the unit based on their molecular weight. Embedding carbon-based powders in the polymeric network will stabilize powders and prevent them from contaminating the liquid. It also adjusts the rate at which absorption and desorption is performed. It is also possible to extract the absorbed molecules from the unit and reuse them by treating the units with proper solvents or other liquid solutions, such as sodium hydroxide with the proper molarity. The units can then be reused without adversely affecting their performance.

These units can be fabricated from natural materials and can be used to increase the sustainability of the process and lower the cost of cell culture in bioreactors and fermenters for different cell types, including mammalian cells and other microorganisms, but their use is not limited to such applications and can be used in any situation where organic components need to be separated from a solution. These units can also be used to continuously remove undesired elements from the solution by directly putting the final product (unit enclosed in dialysis membrane) in contact with the solution or perfusing the solution through the units using hollow fibers with defined cut-offs to keep the concentration of lactate and ammonia at low amounts, significantly lower than their toxic thresholds, to improve performance of cells.

The present invention relates to the manufacture/fabrication of the filter units of the present invention, and the use thereof. The use involves both the trapping (absorption) and the release (desorption) of compounds that are removed from solutions.

### 1. Fabrication of the Filter Units:

In an embodiment, the active part of the units is made of carbon-based particles, and particularly activated charcoal. Activated charcoal is charcoal that has been treated with oxygen at very high temperatures to make it porous, thereby dramatically increasing the surface area of the charcoal, so that it can readily trap/adsorb impurities (e.g., small molecules). Activated carbons (AC) are carbonaceous materials with large specific surface area, superior porosity, high physicochemical-stability, and excellent surface reactivity, extensively used for adsorption of several environmental contaminants, gas separation, heterogeneous catalysis, gas storage, and gas masks, among others. Activated charcoal often has a negative charge associated with it due to the presence of oxygenated groups that allows it to bind compounds that are positively charged, or by allowing binding in a donor-acceptor type of relationship with small molecules (such as benzene derivatives like phenols wherein the activated charcoal is the donor and the phenol is the acceptor).

Examples of activated carbon or activated charcoal particles that can be used in this process include: activated carbon that has been modified with bis(2-ethylhexyl)phosphate (Sigma-Aldrich, St. Louis Missouri) or alternatively unmodified activated carbon that is ideally suited for cell culture and/or plant cell culture (Sigma-Aldrich, St. Louis Missouri).

In an alternative embodiment, the present invention contemplates using lump charcoal pieces that can be used by smashing them into small particles and using sieves for separating particles with known and uniform particle sizes. The uniform charcoal size can than be used as the matrix in the present invention. By using different sieve sizes, different small particle charcoal can be used. The adsorption rate is lower if these particles are used instead of activated carbon. The lump charcoal that can be used is charcoal that one might typically use for barbequing (that does not have a flame inducing solvent accompanying it).

In an embodiment, the units are made by physically trapping carbon-based particles of different sizes and surface area ratios in a polymeric network. Any polymer capable of forming stable networks with controlled properties can be used. Methyl cellulose (MC) is one example of a polymer that can be used. It is readily isolatable from bark, wood or leaves of plants (such as cotton). In a variation, MC can be used for making these units due to its ability to form stable porous network crosslinked with citric acid.

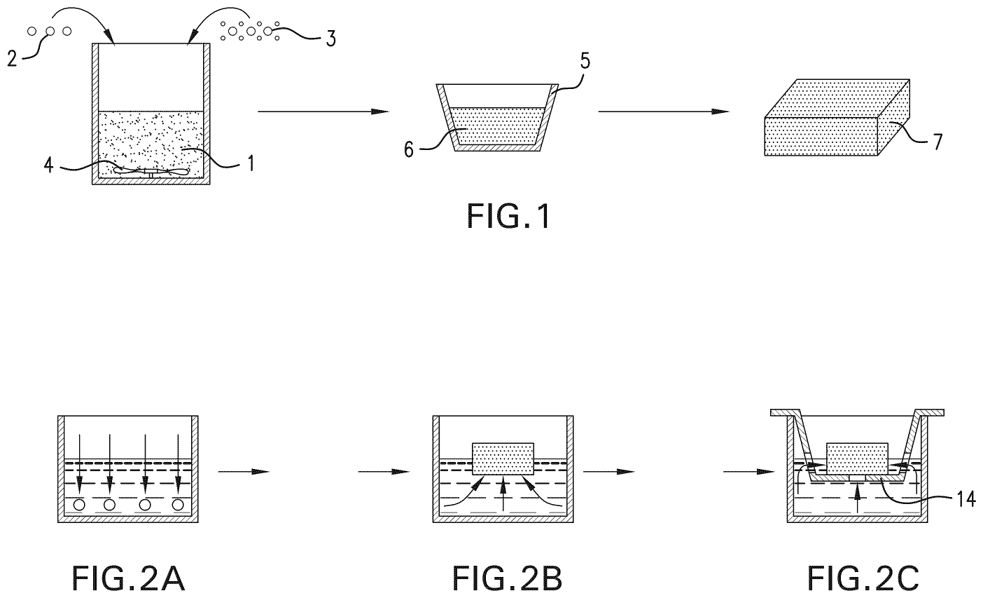

In an embodiment, the process of making a unit of the present invention is shown in FIG. 1. First, a solution of the polymer is made with a predefined weight percentage, in this case MC is made in deionized water. Methyl cellulose can be purified from plant cell walls, or alternatively it can be prepared by reacting methyl chloride with alkali cellulose (for example by treating the cellulose with a base like sodium hydroxide) to generate the methyl ether of cellulose.

In an embodiment, higher weight percentages of the MC result in slower mass transfer and slower filtration/release rates. Similarly, lower weight percentages of the MC result in faster mass transfer and faster filtration/release rates. Subsequently, a desired amount of carbon-based particles can be mixed with this solution. In the case of MC, citric acid dissolved in deionized water is also added to the mix at a pre-defined amount. Once a homogenous solution is made, defined volumes can be added to molds with predefined shapes and sizes wherein the defined volume is sufficient to fill the mold of the predefined size and shape. In an embodiment, the solution is then flash-frozen in liquid nitrogen (so that the mix goes to the solid state quickly) so as to avoid precipitation of the particles. The samples are then freeze-dried (lyophilized) to form the solid units of the present invention. After freeze-drying, the filter units are heated at defined temperatures for a defined amount of time to initiate the crosslinking reaction with citric acid. In an embodiment, the heating step is specific to MC and might not be needed if other polymeric materials are used. For MC specifically, in one embodiment, the mix may be heated at 190° C. for 4 hours. The heating temperature and the timing affect the degree of crosslinking, and consequently molecular weight of the matrix and ultimately, may affect filtration rate. The amount of crosslinking affects the filtration/adsorption and release rates. It should be understood that the amount of reactant time and temperature can be modified to get different amounts of crosslinking and different polymeric molecular weights. Thus, it should be recognized that different MCs with different molecular weights can be used to achieve different filtration/adsorption/release rates.

The present invention contemplates using different molecular weight MC polymer matrices. Higher molecular weight methyl cellulose matrices generally tend to have higher viscosities. Thus, a MC polymer matrix may be used that is anywhere between 15 and 4000 centipose. Methyl cellulose can be procured from commercially available sources at viscosities from about 15 to about 4000 centipose (Sigma Aldrich, St. Louis, Missouri). In an embodiment, hydroxypropyl cellulose can be obtained at levels between 50-50000 centipose (Dupont, Wilmington, DE). It should be understood that any of plurality of different viscosity matrices can be procured.

In an embodiment, other polymer matrices can be used such as other modified polymers are cellulose ethers, such as ethylcellulose (EC), hydroxypropylmethylcellulose (HPMC), hydroxyethylcellulose (HEC) and carboxymethylcellulose (CMC). Cellulose is the most abundant polysaccharide found in nature; it is a regular and linear polymer composed of (1→4) linked β-d-glucopyranosyl units. This particular β-(1→4) configuration together with intramolecular hydrogen bonds gives a rigid structure. Aggregates or crystalline forms are a result of inter-molecular hydrogen bonds occurring between hydroxyl groups, and this structure makes these polymers ideal candidates for use in the present invention.

In a variation, it is contemplated that the filters can be made with other natural or synthetic polymers, such as alginate with calcium chloride as crosslinker, chitosan with dialdehydes, such as formaldehyde or glutaraldehyde as crosslinker, or even different nylons, such as nylon-6,6. Polymers such as nylon don't require the crosslinking step as they are not readily soluble in aqueous solutions used in culture medium or broth. In the case of using non water-soluble polymers, it should be understood that other solvents such as formic acid can be used to dissolve the polymer and, after the porous network is formed and solvents are removed, the units can also be used directly, similar to the use of water soluble polymers (like methyl cellulose).

In an embodiment, other premade products where carbon-based particles are trapped within a stable network can be used for the same purpose (absorption and release) but with limited control over adsorption/release profiles. Unfortunately, the premade products may also possess limited applications due to difficulties surrounding their sterilization. However, if the premade product may be able to survive being autoclaved, the premade product may have use in a context where they need to be sterilized. Examples of such premade products include carbon sponge filters, which may be procured from Amazon, (Amazon, Seattle, Washington) or application specific filter, activated carbon loaded paper, Grade 72 (Sigma-Aldrich, St. Louis, Missouri). Because these do not have the capture/release profiles of the filters that are made by the process of the instant invention, they may have more limited uses for removing lactic acid and ammonia from in vitro cell cultures of mammalian cells.

In one embodiment, FIG. 1 shows the process of making polymeric units with carbon-based particles embedded in the network matrix. The left most figure shows a polymer solution 1 to which cross-linker 2 (e.g., citric acid) and the carbon-based powder 3 (as described above) are added. A mechanical means of stirring may be added (such as a stir bar 4) so as to facilitate the dissolution of the mix. The resulting mix 6 is added to molds 5 of a certain size and shape and rapidly frozen as shown in the middle panel. The rapid freezing may occur by adding the mold to liquid nitrogen (or liquid helium). In the right most panel, the freeze-dried unit 7 (which has the solvent removed) is shown that is ready for use after heating is performed to complete the crosslinking reaction.

### 2. Absorption/Release Applications of the Units:

In an embodiment, carbon particles can be added directly to the media or broth in the absence of the polymer matrix. If the carbon particles are added directly, then they will show a high-speed adsorption of most if not all of the elements of the media without discrimination. When recycling the media and reusing it is the goal, this method is not applicable. The activated carbon particles, in an embodiment, will remain suspended in the media and their removal may prove to be difficult. In any event, even if one were able to remove the activated charcoal from the media, the one or more removal step(s) that would be necessary would make the re-use of the media not cost-effective.

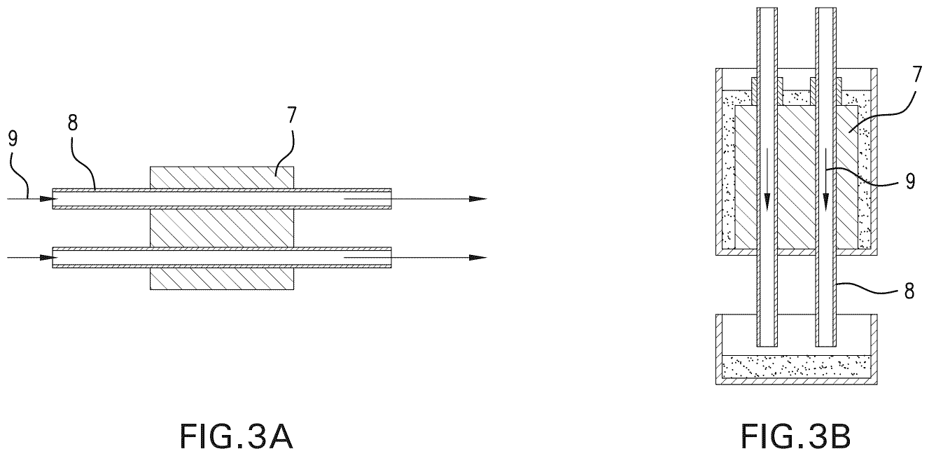

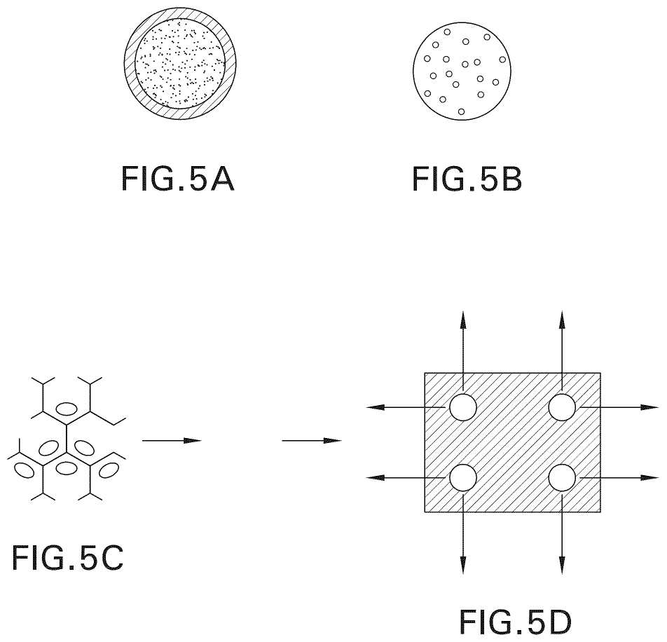

Alternatively, in another embodiment, the units where carbon-based powders are trapped within the polymeric network can be used directly in contact with the liquid. In this case, similar to before, the filter will absorb all of the components of the media, but at a slower rate. Depending on the weight percentage of the polymer solution used in first step of fabrication, the degree of crosslinking, as well as the amount of activated carbon, this rate can be adjusted. Chemical and physical properties of the polymeric network can also affect this rate. For example, the rates can be higher if a hydrophilic polymer, such as MC, is used, as compared to when the network is hydrophobic, such as in case of nylon 6,6. A certain degree of control can be applied to the molecules absorbed by the units by controlling the molecular weight of the molecules that can be absorbed. This can be achieved by separating the unit from the solution with a dialysis membrane with a defined molecular weight cut-off. Membranes with smaller cut-offs allow more strict control over the molecules absorbed to the unit. A 500 Da cut-off can be used where the goal is to separate lactate and ammonia (see FIG. 2). The membrane 14 is shown in FIGS. 2C and 4C.

FIG. 2 shows three different embodiments. FIG. 2A shows the activated carbon, which has been added directly to the media. The arrows show that molecules present in the media are adsorbing to the activated carbon (the circles). The embodiment in FIG. 2B shows the unit (the hatched box) of the present invention which contains the polymer matrix containing activated carbon. Molecules in the media are absorbing to the unit as indicated by the arrows. In this embodiment, the media is directly in contact with the unit. FIG. 2C shows the unit which is inside a molecular weight cut-off membrane. Only the molecules in the media that are smaller than the molecular weight cut-off of the membrane are able to pass through the cut-off membrane and absorb to the unit (which contains the polymer matrix and the activated carbon). In this embodiment, the media is indirectly in contact with the unit.

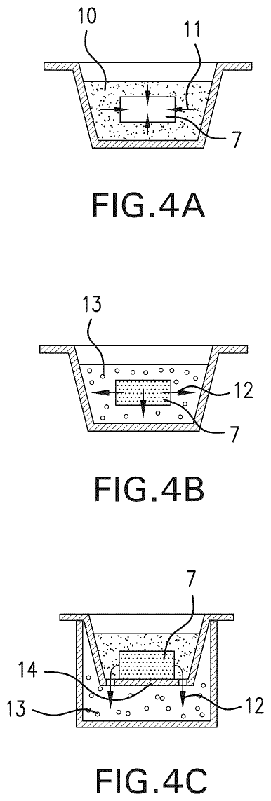

One alternative to the dialysis membrane that is shown in FIG. 2C is an embodiment that comprises hollow-fiber tubes. Similar to dialysis membranes, hollow-fiber tubes have defined cut-offs and are made of different materials. They can be embedded within the filters (i.e., the polymer matrix) in order to allow the passage of a solution through them either actively by perfusion or passively, for example by gravitational force. Molecules that are bigger than the hollow-fiber tube cut-off are not able to pass. It is also possible to embed the units inside the fibers and allow the solution to perfuse around the fibers (FIG. 3).

FIG. 3 shows two embodiments of the present invention. In embodiment 3A, the unit 7 contains hollow-fiber tubes 8 that allows the passage of solution through the hollow-fiber tubes 8 in the position and direction of arrows 9. The hollow-fiber tubes are similar to a molecular weight cut-off dialysis membrane because molecules that are present in the solution (media) when they enter the tube they can pass through the tubes (in a vertical direction as shown in FIG. 3A) to adsorb to the activated carbon in the unit 7 (unit 7 comprises a polymer matrix and the activated carbon inside the polymer matrix). Accordingly, the tubes act as a filter so that the media that enters the tubes perfuses through the tubes meaning the media enters the tube with a higher concentration of the molecules (for example, lactic acid and ammonia) than are present when the media exits the tubes because as the media traverses the tubes, the molecules that are below the molecular weight cut-off perfuse through the tube allowing the molecules to absorb to the unit 7.

Similarly, embodiment 3B shows hollow-fiber tubes 8 wherein the media traverses through the hollow-fiber tubes that are situated in the unit 7. In this embodiment, the media traverses in the direction of arrows 9 through the hollow-fiber tubes by gravitational means. As the media traverses through the hollow-fiber tubes, the small molecules that are smaller than the molecular weight cut-off of the hollow-fiber tubes 8 allows these molecules to perfuse through the hollow-fiber tubes 8 and adsorb to the activated carbon, which is present in unit 7.

Although a principal function of these units 7 is filtering out smaller molecules, the units can also be used to release/desorb other molecules with a controlled rate and create a constant concentration of those released factors in the solution (e.g., media). In an embodiment, this may be beneficial in the case of molecules that are used by the cells at higher rates, such as glucose, in order to keep their concentration constant and improve the efficiency of the culture system. In order to release the molecules, the units can be directly in contact with a high volume of solution that is saturated with the target molecules to fully absorb the maximum possible amount of the target molecules. If this unit is put in contact with either a new solution that doesn't contain the target molecule or only contains lower concentrations, then, either directly or indirectly through a dialysis membrane or hollow fiber tube, assuming the cut-off is larger than the molecule's size, the unit will release the molecule to the solution at a defined rate (see FIG. 4).

FIG. 4A shows an embodiment where the unit 7 is undergoing saturation by the molecules that are absorbing to the unit. Arrows 11 indicate the general direction of the concentration gradient of the molecules. That is, more molecules are absorbing to the unit 7 than are being desorbed meaning that the concentration of molecules that absorb to the unit in the medium 10 is decreasing. Once a saturation point of molecules absorbed to the unit is reached, the unit can be used, for example, as in FIG. 4B, wherein more molecules are desorbed than are being absorbed. If a concentration gradient is introduced to the saturated unit wherein the medium does not have the molecule that is absorbed to the unit (for example, if a new medium is introduced that does not contain the absorbed molecule), a concentration gradient is created by the introduction of the newly introduced medium 13. The consequence of the newly introduced medium 13 is to have the unit 7 desorb the molecules such that the net concentration of molecules is moving in the direction of arrows 12. That is, the medium 13 is having the absorbed molecule on the unit 7 desorb from the unit 7, so that molecules are being added to the newly introduced medium 13. Similarly, FIG. 4C undergoes the same net movement (arrows 12) of molecules from the unit 7 into the newly introduced medium 13 even if a dialysis membrane 14 is introduced.

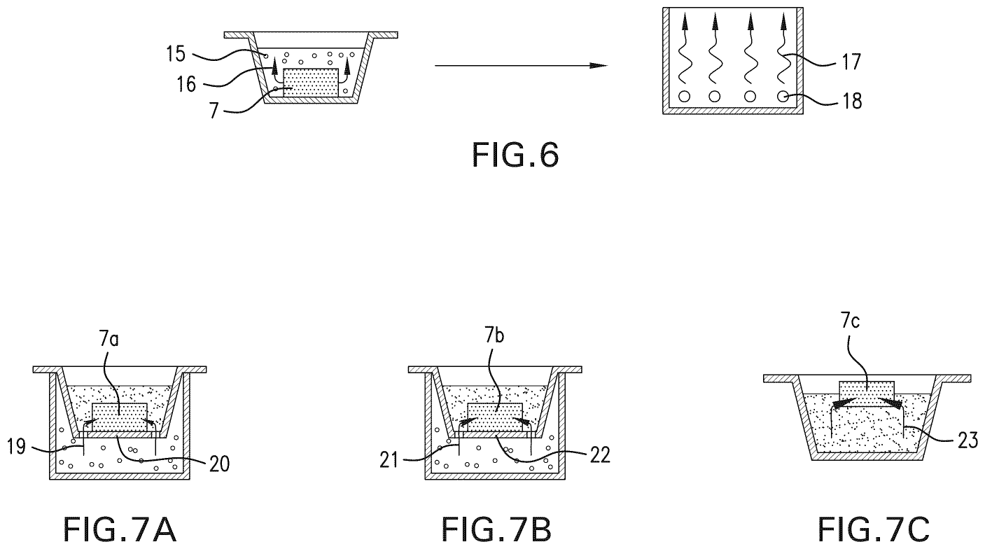

Alternatively, in another embodiment, the molecules intended to be released from the unit can be used with a carrier and then embedded in the polymeric network containing activated carbon. These carriers could be in the form of polymeric reservoirs and liposomes (FIG. 5A), matrix systems (FIG. 5B), dendrimers (FIG. 5C), or other means that provide controlled release profile and can be inserted into the polymer matrix of the present invention (FIG. 5D). The use of these controlled delivery systems provides another level of control over the release (desorption) of the small molecules.

### 3. Desorption of the Adsorbed/Absorbed Elements:

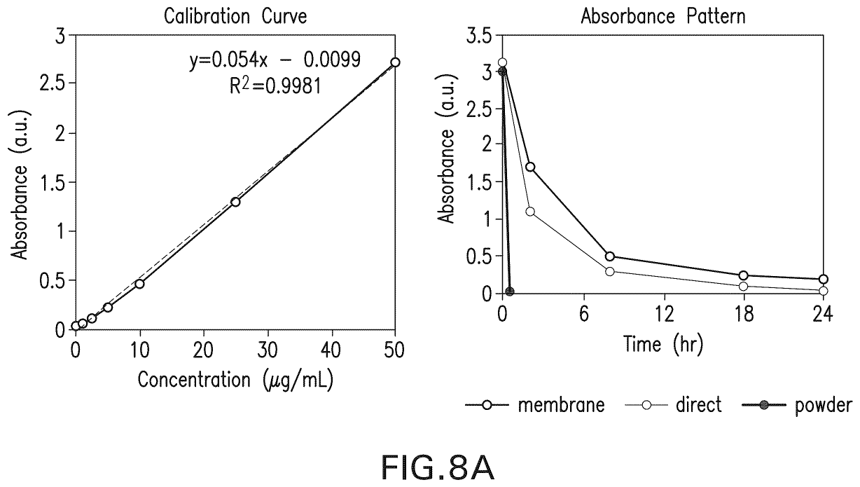

In an embodiment, the molecules absorbed to the units can be released by using a proper solvent with higher affinity to the target molecules. In one embodiment, acetone can be used for both lactate and ammonia. Alternatively, a 0.1N NaOH solution (or a NaOH solution of other concentration) can be used with lactate as the capacity of the units to hold lactate decreases with increasing pH, thereby allowing lactate to be desorbed from the unit. Other solvents such as C₁₋₆ alcohols can be used as well. In one variation, isopropanol can be used. If the solvent is chosen with care such that it doesn't damage the polymeric network, the filter can be reused indefinitely. The solvent can then be allowed to evaporate, and the absorbed molecules can be collected for other applications. (FIG. 6). FIG. 6 shows a two step process wherein different molecules that are adsorbed to the unit can be selectively desorbed. First, the filter unit 7 is introduced to a particular solvent 15 that allows the desorption 16 of the molecule of interest. In essence, the particular solvent 15 is extracting the desired molecule into the solvent. In the second step of the process, the solvent 17 is evaporated to leave the molecule of interest 18. The process may be facilitated by using a methodology similar to the process that a rotary evaporator uses. By using reduced pressure, the solvent can be evaporated more rapidly at a lower temperature than would be necessary in the absence of the reduced pressure. In a subsequent step, the process may be repeated in a separate solvent to extract other molecules that may be absorbed to the unit.

In one embodiment, a classical distillation procedure can be implemented to separate the components based on their molecular weights (using the boiling points) to collect the solvent at the end to be reused in the process. If different components are absorbed to the units, and those components require different solvents for desorption, a step-wise treatment with these solvents can be performed instead of the distillation process. Thus, the polymeric network can provide a unique process whereby desorption of different absorbed molecules can occur as needed.

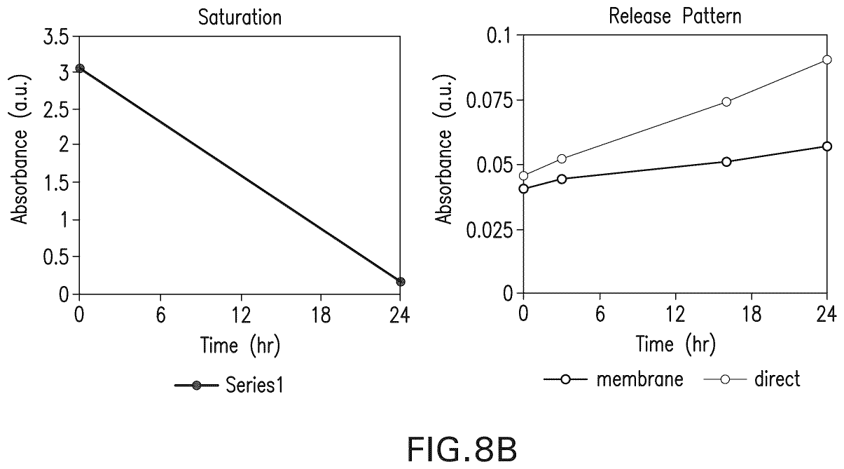

In another embodiment, it is also possible to put solvents in contact with the filters indirectly through dialysis membranes with an incremental increase in their molecular weight cut-offs (FIG. 7). This multi-step process will allow different molecules to be absorbed to different filters based on their molecular weights and simplify the separation of the molecules in the downstream processes. Accordingly, the earlier used filter that is used in conjunction with a lower molecular weight cut-off dialysis membrane will have molecules that are of lower molecular weight than the filters that are used subsequently that are used with higher molecular weight cut-off dialysis membranes. FIG. 7 shows a three-step process that illustrates the overall process. In FIG. 7A, the unit 7a has a molecular weight cut-off dialysis membrane 20 that allows molecules that are smaller than the cut-off to be absorbed by the filter unit 7a. The relative sizes of arrows 19, 21, and 23 are indicative of the relative molecule sizes by molecular weight that are being absorbed by the filter unit 7. In FIG. 7B, a molecular weight cut-off dialysis membrane 22 is used that is greater than the molecular weight cut-off dialysis membrane 20 used in 7A. Accordingly, molecules are absorbed by filter unit 7b that are of a molecular weight that is between the molecular weight cut-off dialysis membrane 20 used in FIG. 7A and the molecular weight cut-off dialysis membrane 22 used in FIG. 7B. In FIG. 7C, no molecular weight cut-off dialysis membrane is used and molecules that are of any size are absorbed by the filter unit 7c. This allows different filter units 7a-c to have different molecules absorbed by them.

It should be understood that this process can be used in conjunction with different solvents and with concentration gradients as discussed above so that the process can be made even more selective in isolating molecules that are absorbed/desorbed by/from the filter unit.

### EXAMPLE(S)

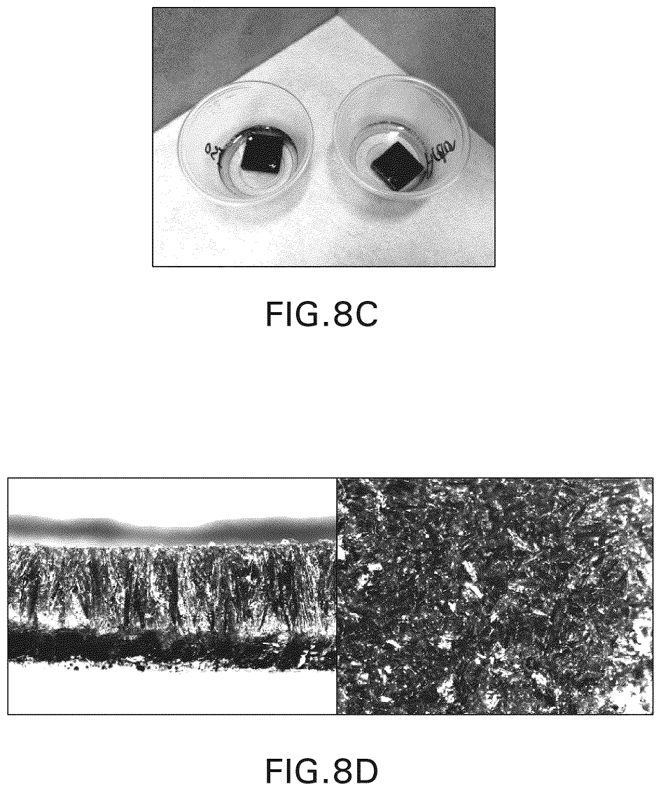

Toluidine blue (TB) was used as a target molecule to show the case of both filtration and release of the small molecules from the units. TB was used because it can be visualized by the naked eye. A calibration curve was prepared for TB by measuring the absorbance of its solution at different concentrations ranging from 0-50 μg/mL at 590 nm. The results can be seen in the graph shown in FIG. 8A. Using Beer's law, the extinction coefficient was calculated.

Subsequently, the units were made using a 6% wt/V solution of MC 15 centipoise (cp). After MC was dissolved, citric acid and activated carbon were added to achieve 1% wt/V for both. Molds with 1×1 cm cross-section were used with 1.5 mL of this solution. After units were flash-frozen and freeze-dried, heating was performed at 190° C. for 4 hrs to complete the crosslinking and stabilization of the units.

To first showcase the ability of the filters in absorbing TB from its aqueous solution, three conditions were used with a 50 μg/mL and samples were taken every few hours to measure the absorbance. First, activated carbon powders were used without the MC polymeric network. Second, the units (comprising the polymeric network and the activated carbon) were used in direct contact with the solution. And third, the units were used indirectly through a dialysis membrane with a 2 kDa cut-off. The powders adsorbed the entire TB in less than 1 hr while it took up to 24 hours for units to absorb the majority of the TB. Although the molecular weight of TB was significantly smaller than the cut-off of the membrane, the presence of the membrane slowed down the absorbance of the molecules (see the right-hand graph of FIG. 8A).

In the next experiment, the units were exposed each to 10 mL of a 50 μg/mL solution of TB for 24 hrs to absorb the TB and become saturated. An absorbance measurement revealed an almost complete removal of TB from the solution. These saturated units were then put direct and indirect contact with 2 mL deionized water, either directly by placing the unit directly in the deionized water or indirectly through 2 kDa dialysis membranes, and the absorbance of this aqueous solution was measured every few hours over a 24-hour period. Both the direct and indirect contact showed the slow release of TB and, similar to before, the presence of the membrane resulted in a slower release rate. The release rate was also significantly slower than the absorbance rate (FIG. 8B).

Saturated units were also treated with both acetone and isopropanol, and desorption of TB molecules started in both cases after only 5 minutes (FIG. 8C). The cross-sectional and top view of the units is shown in FIG. 8D.

These results show that the units comprising a polymeric matrix and activated carbon are effective at absorbing a molecule such as TB. Although the adsorption rate is not as fast for the units relative to activated carbon without the polymer matrix, it should be understood that this slower rate may be desirable in cases where one wants absorption to be slower. It is expected that one can add additional filter units to speed the process so that the rate can be adjusted to the ideally desired rate. Moreover, the polymeric matrix can be manipulated as described herein to adjust the rate of adsorption uptake.

One advantage to the use of the filter units of the present invention relative to using activated carbon without a polymeric matrix is the facility with which the filter units can be removed. Because the filter units are self contained with the activated carbon in them, they can simply be removed by lifting them out of solution. In contrast, activated carbon needs to be filtered, which not only requires additional time but sometimes leads to the inability to remove all of the activated carbon from the solution (media).

Regarding the desorption rate, the present invention contemplates that different solvents can be used to adjust the rate of desorption with the possibility that mixes of solvents may be used to give the ideal desorption rate. Moreover, the use of dialysis membranes may be used to also adjust the rate and the types of compounds that are desorbed from the units. By varying the number of units used, the polymeric composition of the units, different molecular weight cut-off dialysis membranes, and the types of solvents used, one can achieve an almost infinite number of possible desorption rates.

In an embodiment, the present invention relates to compositions and methods of creating and using filter units that comprise a polymeric matrix into which activated carbon has been inserted. In a variation, the present invention relates to a filter unit that comprises a) a polymer matrix and b) activated carbon. In a variation, the polymer matrix comprises a cellulosic polymer matrix. In a variation, the polymer matrix comprises methyl cellulose.

In an embodiment, the activated carbon is activated charcoal and the activated charcoal is present in the polymer matrix. In a variation, the filter unit is substantially free of solvent. In a variation, the filter unit is substantially free of water because any solvent that was present has been removed by evaporation or by freeze drying.

In an embodiment, the filter unit further comprises one or more of a molecular weight cut-off dialysis membrane or a hollow-fiber tube. The one or more of a dialysis membrane or a hollow-fiber tube has a molecular weight cut-off of 0.1-5000 Da, or alternatively, 0.1-4000 Da, or alternatively, 0.1-3000 Da, or alternatively, 0.1-2000 Da, or alternatively 0.1-1000 Da, or alternatively, 0.1-500 Da.

In an embodiment, the filter unit may be further used with carriers that may be in the form of polymeric reservoirs and liposomes that are often used as drug delivery vehicles, in other matrix systems, with dendrimers, or with other carriers that provide a controlled release profile and can be inserted into the polymer matrix.

In an embodiment, the polymeric matrix is methyl cellulose. Alternatively, the polymeric matrix is a different cellulosic polymer, an alginate polymer, a chitosan polymer, or a nylon polymer.

In an embodiment, the filter unit is capable of absorbing lactate and/or ammonia. In a variation, the filer unit absorbs both lactate and ammonia. In a variation, the lactate and/or ammonia can be desorbed from the filter unit.

In an embodiment, the filter unit further comprises a crosslinker. In a variation, the crosslinker allows the crosslinking of the methyl cellulose to generate a polymer matrix that is able to incorporate activated charcoal. In a variation, different and varying amounts of crosslinker and methyl cellulose can be added to change the physical properties of the polymer matrix.

In an embodiment, the crosslinker is citric acid, and the filter unit is made by dissolving the polymer matrix into a solvent, adding the activated carbon and crosslinker to form a solution, optionally heating the solution, pouring the solution into a form, freezing the form containing the solution, and freeze drying the solution to remove the solvent. In a variation, the filter unit is removed from the form and added to a solution that contains a molecule that is to be removed from the solution.

In an embodiment, the present invention relates to methods of producing a filter unit comprising: dissolving a polymer or a monomer into a solvent to generate a solution, adding a crosslinker and activated carbon to the solution to generate polymer matrix that comprises the activated carbon in a mixed solution, pouring the mixed solution into a form, rapidly freezing the mixed solution and the form, and lyophilizing the mixed solution to remove the solvent. In a variation, the monomer that is added to the solution polymerizes to form a polymer. In an embodiment, the polymer matrix may comprise a homopolymer, a co-polymer, or a terpolymer. In a variation, different monomers may be added to the solvent to generate a co-polymer or a terpolymer. In an embodiment, the monomer may be glucose or another sugar. In an embodiment, the sugar may be allose, altrose, glucose, mannose, gulose, idose, galactose, or talose.

In an embodiment, the method uses a polymer matrix that comprises one or more members selected from the group consisting of a cellulosic polymer, an alginate polymer, a chitosan polymer, and a nylon polymer. In a variation, the crosslinker may be citric acid, calcium chloride, formaldehyde or glutaraldehyde. In a variation, the polymer matrix comprises a nylon that is nylon-6,6.

In an embodiment, the method uses a polymer matrix that comprises methyl cellulose that has been crosslinked with citric acid. In a variation, the method further comprises a heating step. In a variation, the heating step is used to crosslink the polymer and/or to allow the activated charcoal to incorporate into the polymer matrix.

In an embodiment, the present invention relates to a method of removing a molecule by absorbing from a solution, the method comprising adding a filter unit to the solution, wherein the filter unit comprises a polymer matrix that contains activated carbon, allowing the filter unit to absorb the molecule, and removing the filter unit from the solution thereby removing the molecule from the solution. In a variation, the activated carbon is activated charcoal, and the activated charcoal is present inside the polymer matrix, and wherein the polymer matrix is methyl cellulose. In a variation, the polymer matrix has been crosslinked with a crosslinker. In a variation, the crosslinker is citric acid. In a variation, the molecule is recovered by desorbing the molecule from the filter unit.

In an embodiment, the method of the present invention relates to removing lactic acid and/or ammonia from a cell culture media using the filter units as described above. In a variation, the lactic acid and/or ammonia can be recycled and used for other purposes. In a variation, the filter unit can be recycled and re-used to remove more lactic acid and/or ammonia. In a variation, the filter unit can be used in conjunction with molecular weight cut-off dialysis membranes. In a variation, the filter unit can be used with deionized water or another appropriate solvent. Other solvents include lower alkanols, acetone, or other solvents that may be used in biological systems. In a variation, the filter unit comprises a polymeric matrix that is made by combining methyl cellulose, activated carbon/charcoal, and citric acid. In a variation, the filter unit does not contain any solvent. In a variation, the filter unit is added to a bioreactor that is undergoing cell growth/expansion to remove lactic acid and/or ammonia as the cells expand/propagate. In a variation, a plurality of filter units can be used to more rapidly remove the lactic acid and/or ammonia. In a variation, the polymer matrix physical properties can be adjusted so as to adjust the rate of removal of the lactic acid and/or ammonia. In a variation, the physical properties can be adjusted by adjusting the viscosity of the polymer matrix, and/or the concentrations of the various components that are used to make the polymer matrix.

The following references are incorporated by reference in their entireties for all purposes.
Zhou, W., J. Rehm, and W. S. Hu, High viable cell concentration fed-batch cultures of hybridoma cells through on-line nutrient feeding. Biotechnol Bioeng, 1995. 46(6): p. 579-87.
Cruz, H. J., et al., Effects of ammonia and lactate on growth, metabolism, and productivity of BHK cells. Enzyme Microb Technol, 2000. 27(1-2): p. 43-52.
Gao, M. T., et al., pH-Uncontrolled lactic acid fermentation with activated carbon as an adsorbent. Enzyme Microb Technol, 2011. 48(6-7): p. 526-30.
Zamfirescu, C. and I. Dincer, Ammonia as a green fuel and hydrogen source for vehicular applications. Fuel Processing Technology, 2009. 90(5): p. 729-737.
Parmeggiani, F., et al., Synthetic and Therapeutic Applications of Ammonia-lyases and Aminomutases. Chem Rev, 2018. 118(1): p. 73-118.
Sikdar, S. K. and S. B. Sawant, Ammonia Removal from Mammalian Cell Culture Medium by Ion-Exchange Membranes. Separation Science and Technology, 1994. 29(12): p. 1579-1591.
Liew, M. K. H., S. Tanaka, and M. Morita, Separation and purification of lactic acid: Fundamental studies on the reverse osmosis down-stream process. Desalination, 1995. 101(3): p. 269-277.
Ebersold, M. F. and A. L. Zydney, The effect of membrane properties on the separation of protein charge variants using ultrafiltration. Journal of Membrane Science, 2004. 243(1): p. 379-388.
Lin, J., et al., Extractive fermentation of 1-lactic acid with immobilized Rhizopus oryzae in a three-phase fluidized bed. Chemical Engineering and Processing: Process Intensification, 2007. 46(5): p. 369-374.
Ye, K., S. Jin, and K. Shimizu, Performance improvement of lactic acid fermentation by multistage extractive fermentation. Journal of Fermentation and Bioengineering, 1996. 81(3): p. 240-246.
Vaccari, G., et al., Fermentative production of 1-lactic acid by Lactobacillus casei DSM 20011 and product recovery using ion exchange resins. Applied Microbiology and Biotechnology, 1993. 40(1): p. 23-27.
Chen, C.-C. and L.-K. Ju, Adsorption Characteristics of Polyvinylpyridine and Activated Carbon for Lactic Acid Recovery from Fermentation of Lactobacillus delbrueckii. Separation Science and Technology, 1998. 33(10): p. 1423-1437.
Chen, C. and L. K. Ju, Coupled lactic acid fermentation and adsorption. Appl Microbiol Biotechnol, 2002. 59(2-3): p. 170-4.

It should be understood and it is contemplated to be within the scope of the present invention that any feature that is disclosed or used herein can be combined with any other feature even if they are not mentioned together as long as they are compatible with each other. When ranges are mentioned, it is within the scope of the invention that any endpoint that fits within that range is contemplated as an end-point for a sub-range, even if that sub-range and/or end point is not specifically recited. Moreover, modifications to the present invention can be made that do not deviate from the spirit and scope of the present invention. In any event, the present invention is defined by the below claims.

We claim:

1. A filter unit that comprises a) a polymer matrix and b) activated carbon.

2. The filter unit of claim 1, wherein the polymer matrix comprises a cellulosic polymer matrix.

3. The filter unit of claim 2, wherein the polymer matrix comprises methyl cellulose.

4. The filter unit of claim 1, wherein the activated carbon is activated charcoal and the activated charcoal is present in the polymer matrix.

5. The filter unit of claim 4, wherein the filter unit is substantially free of solvent.

6. The filter unit of claim 5, wherein the filter unit further comprises one or more of a molecular weight cut-off dialysis membrane or a hollow-fiber tube.

7. The filter unit of claim 6, wherein the polymeric matrix is methyl cellulose.

8. The filter unit of claim 7, wherein the filter unit is capable of absorbing lactate and/or ammonia.

9. The filter unit of claim 1, wherein the filter unit further comprises a crosslinker.

10. The filter unit of claim 9, wherein the crosslinker is citric acid, and the filter unit is made by dissolving the polymer matrix into a solvent, adding the activated carbon and crosslinker to form a solution, heating the solution, pouring the solution into a form, freezing the form containing the solution, and freeze drying the solution to remove the solvent.

11. A method of producing a filter unit comprising: dissolving a polymer or a monomer into a solvent to generate a solution, adding a crosslinker and activated carbon to the solution to generate polymer matrix that comprises the activated carbon in a mixed solution, pouring the mixed solution into a form, rapidly freezing the mixed solution and the form, and lyophilizing the mixed solution to remove the solvent.

12. The method of claim 11, wherein the polymer matrix comprises one or more members selected from the group consisting of a cellulosic polymer, an alginate polymer, a chitosan polymer, and a nylon polymer.

13. The method of claim 12, wherein the polymer matrix is the cellulosic polymer.

14. The method of claim 13, wherein the polymer matrix comprises methyl cellulose that has been crosslinked with citric acid.

15. The method of claim 14, wherein the method further comprises a heating step.

16. A method of removing a molecule by absorption from a solution, said method comprising adding a filter unit to said solution, wherein said filter unit comprises a polymer matrix that contains activated carbon, allowing said filter unit to absorb the molecule, and removing the filter unit from the solution thereby removing the molecule from the solution.

17. The method of claim 16, wherein the activated carbon is activated charcoal, and the activated charcoal is present inside the polymer matrix, wherein the polymer matrix is methyl cellulose.

18. The method of claim 17, wherein the polymer matrix has been crosslinked with a crosslinker.

19. The method of claim 18, wherein the crosslinker is citric acid.

20. The method of claim 16, wherein the molecule is recovered by desorbing the molecule from the filter unit.
